(19) United States
(12) Patent Application Publication
(10) Pub. No.: US 2016/0279916 A1
(43) Pub. Date: Sep. 29, 2016

(54) CHIP PRESS DEVICE AND CHIP PRESS METHOD

(71) Applicants: BOE TECHNOLOGY GROUP CO., LTD., Beijing (CN); BOE (HEBEI) MOBILE DISPLAY TECHNOLOGY CO., LTD., Hebei (CN)

(72) Inventors: Yongming ZHANG, Beijing (CN); Yelei XIA, Beijing (CN)

(21) Appl. No.: 14/801,222

(22) Filed: Jul. 16, 2015

(30) Foreign Application Priority Data
Mar. 24, 2015 (CN) 201510131893.8

(51) Int. Cl. B32B 37/10

(52) U.S. Cl. CPC B32B 37/10; B32B 2457/20

(57) ABSTRACT

A chip press device and a chip press method are disclosed. The chip press device includes a base, a hot pressing head and a buffer, and a bearing surface of the base is a convex surface. The bearing surface of the base being a convex surface allows a display panel to deform slightly downwards during the chip pressing process. When the chip press is finished, the display panel deforms upwards under the shrinkage of the chip. Since the upwards deformation amount counteracts the downwards deformation amount, the warpage of display panel in conventional chip pressing process can be eliminated, which further avoids uneven uneven chromatic aberration in displayed images and improves the product quality.

### FIELD OF THE ART

Embodiments of the invention relate to a chip press device and a chip press method performed thereby.

### BACKGROUND

Chip press technologies for display panels refer to the following: pressing a chip by using a heated pressing head against a buffer under certain temperature, pressure and pressing time, allowing the chip to react with an anisotropic conductive adhesive disposed on a press-fit end of a display panel, thereby bonding the chip to the display panel and electrically connecting the chip to the display panel. As the heat is conducted from the pressing head to the display panel through the chip during the pressing process, the amount of thermal extension of the chip is larger than that of the display panel under the chip, which will causes an upward warpage to the display panel after finishing the chip press, under the shrinkage of the chip. As a result, an uneven chromatic aberration caused by the warpage presents in images displayed by the display panel, i.e., mura.

### SUMMARY

A first aspect of the invention provides a chip press device, comprising a base, a hot pressing head and a buffer, wherein a bearing surface of the base has a specific convexity.

A second aspect of the invention provides a chip press method performed by using the above chip press device, comprising: placing an press-fit end of a display panel on the bearing surface of the base; aligning the chip with the press-fit end of the display panel; placing the buffer on the chip; and pressing the chip by using the hot pressing head against the buffer.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 schematically illustrates a chip press device in working state in accordance with an embodiment of the invention;

FIG. 2 schematically illustrates a chip and a press-fit end of a display panel after the hot press is performed in accordance with an embodiment of the invention;

FIG. 3 schematically illustrates a perspective view of a chip press device in accordance with an embodiment of the invention; and

FIG. 4 schematically illustrates a structure of a base in accordance with another embodiment of the invention.

### NUMERAL REFERENCES

1—base; 2—hot pressing head; 3—buffer; 4—bearing surface; 5—jack screw; 6—display panel; 7—press-fit end; 8—chip; 9—anisotropic conductive adhesive; 10a, 10b—heating rod.

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

For the purpose of eliminating warpage of display panels in conventional chip pressing processes and thereby avoiding uneven chromatic aberration in displayed images and improving the product quality, the following embodiments of the invention provide a chip press device and a chip press method.

As illustrated in FIGS. 1 to 3, a chip press device provided by an embodiment of the invention comprises a base 1, a hot pressing head 2 (a heating rod 10a may be disposed therein) and a buffer 3. Herein, a bearing surface 4 of the base 1 is a convex surface, and a vertical distance from the highest point to the lowest point of the convex surface is 1.

The chip press device presses a chip 8 to a press-fit end 7 of a display panel 6. An anisotropic conductive adhesive 9 is disposed on the press-fit end 7 of the display panel 6. The hot pressing head 2 presses the chip 8 against the buffer 3 under certain temperature, pressure and pressing time, allowing the chip 8 to react with the anisotropic conductive adhesive 9, thereby bonding the chip 8 to the display panel 6 and electrically connecting the chip 8 to the display panel 6.

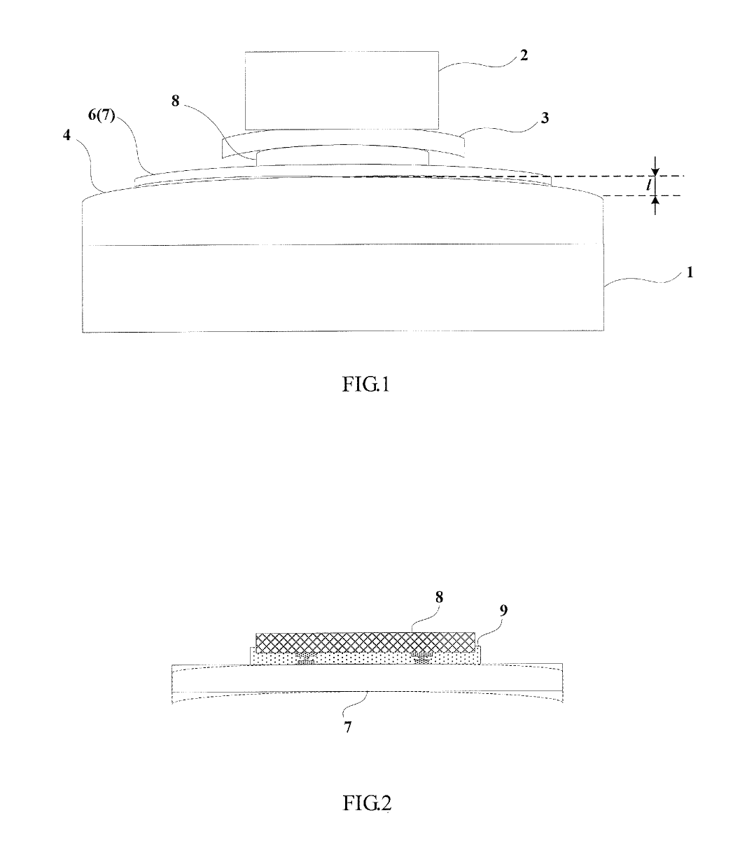

As illustrated in FIGS. 1 and 2, in the technical solution of the above embodiment, the bearing surface 4 of the base 1 is a convex surface which will cause the display panel 6 to bend (deform) slightly downwards under the pressure during the chip pressing process (as illustrated by the dashed box of FIG. 2). When the pressing process is finished, the display panel 6 deforms upwards under the shrinkage of the chip 8, with the upwards deformation amount counteracting the downwards deformation amount, thereby solving the problem of warpage in conventional chip pressing process, which further avoids uneven chromatic aberration in displayed images and improves the product quality.

In above embodiment, the vertical distance l may be determined according to a deformation amount of the display panel 6 caused by the chip shrinkage. In the embodiment, the vertical distance l may be set as being equal to the amount of the warpage. In case that the bearing surface 4 is a flat surface, the display panel 6 warps upwards by about 0.02 mm when the chip pressing is finished. Accordingly, the vertical distance l is set to be about 0.02 mm in the embodiment. The curvature (also called radian) of the bearing surface 4 can be precisely determined in this way, thereby eliminating the warpage of the display panel 6 in the chip pressing process and further maintaining the flatness of the final display panel 6 to the largest extent.

The amount of warpage of display panels are usually within the range from 0.01 mm to 0.1 mm in conventional chip pressing processes. Due to the above fact, in at least one embodiment of the invention, the vertical distance l is set to be from 0.01 mm to 0.1 mm, thereby eliminating the warpage of the display panel 6 in the chip pressing process, which further avoids uneven chromatic aberration in displayed images and improves the product quality.

Specific material of the base 1 will not be limited here and it may be made of any material, such as quartz, steel and the like. As illustrated in FIG. 4, in an embodiment of the invention, the base 1 is a stainless steel base, and a plurality of jack screws 5 for adjusting the curvature of the bearing surface 4 are disposed under the bearing surface 4 of the stainless steel base. The plurality of jack screws 5 is disposed inside the base 1. In the base 1 with the above structure, the curvature of the bearing surface 4 may be continuously adjustable. Thus, the base 1 is suitable for pressing display panels with chips having various deformation amounts, which is beneficial to save the cost of devices.

Specific material of the buffer 3 will not be limited here. For example, the buffer is a silica gel buffer or any other composite material buffer. The buffer 3 is capable of mitigating the pressure and heat conduction from the hot pressing head 2, thereby preventing the chip 8 from being damaged by the uneven pressure or uneven heat conduction.

In at least one embodiment of the invention, the thickness of the buffer 3 is larger than the vertical distance 1. By this means, the pressures at both sides of the chip 8 may be compensated during the chip pressing process, thereby guaranteeing the homogeneity of the pressure and improving the reliability of the pressing. For example, the thickness of the buffer 3 is about 0.25 mm.

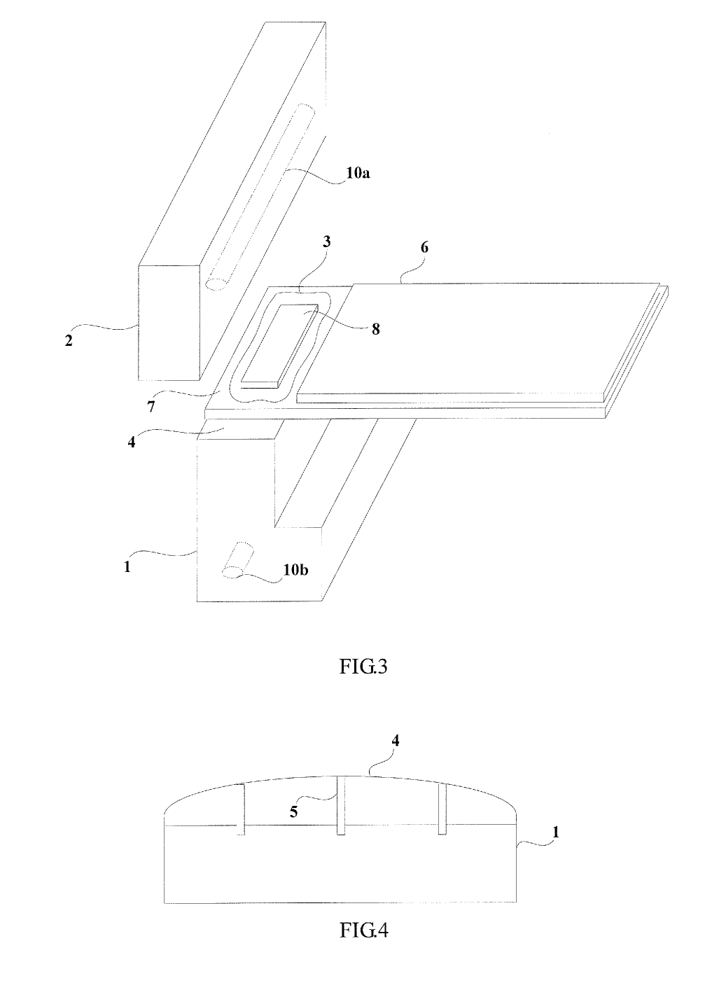

In at least one embodiment of the invention, as illustrated in FIG. 3, the base 1 is an auxiliary heating base (for example, provided with a heating rod 10b inside), and has a working temperature of no more than 120° C. (≦120° C.). The auxiliary heating base is capable of moderately reducing the working temperature of the hot pressing head 2, thereby reducing the temperature difference between the top and the bottom sides of the display panel 6. Such a design is also beneficial to reduce the warpage of the display panel 6 in the chip pressing process.

Another embodiment of the invention provides a chip press method performed by the chip press device in any one of the above embodiments, the method comprises:

placing an press-fit end 7 of a display panel 6 on a bearing surface 4 of the base 1;

aligning the chip 8 with the press-fit end 7 of the display panel 6;

placing a buffer 3 on the chip 8; and

pressing the chip 8 by using a hot pressing head 2 against the buffer 3.

The display panel 6 deforms slightly downwards during the chip pressing process. When the chip pressing process is finished, the display panel 6 deforms upwards under the shrinkage of the chip 8. The upwards deformation amount exactly counteracts the downwards deformation amount.

It is seen that the chip press device in the embodiment of the invention can eliminate the warpage of the display panel caused by the chip pressing process, which further avoids uneven chromatic aberration in displayed images and improves the product quality.

What is described above is related to the illustrative embodiments of the disclosure only and not limitative to the scope of the disclosure; the scopes of the disclosure are defined by the accompanying claims.

This application claims the priority of Chinese Application No. 201510131893.8, filed on Mar. 24, 2015, the disclosure of which is incorporated herein by reference in its entirety.

What is claimed is:

1. A chip press device, comprising: a base, a hot pressing head, and a buffer, wherein a bearing surface of the base is a convex surface.

2. The chip press device of claim 1, wherein a vertical distance from a highest point to a lowest point of the convex surface is determined according to a deformation amount of a display panel caused by chip shrinkage.

3. The chip press device of claim 1, wherein a vertical distance from a highest point to a lowest point of the convex surface is from 0.01 mm to 0.1 mm.

4. The chip press device of claim 1, wherein the base is a quartz base.

5. The chip press device of claim 1, wherein the base is a steel base, and a plurality of jack screws configured for adjusting a curvature of the bearing surface are disposed under the bearing surface.

6. The chip press device of claim 1, wherein a thickness of the buffer is larger than a vertical distance from a highest point to a lowest point of the convex surface.

7. The chip press device of claim 6, wherein the thickness of the buffer is 0.25 mm.

8. The chip press device of claim 6, wherein the buffer comprises a silica gel buffer.

9. The chip press device of claims 1, wherein a heating element is disposed in the base and a working temperature of the base is equal to or smaller than 120° C.

10. A chip press method performed by using the chip press device of claim 1, the method comprising:
placing a press-fit end of a display panel on the bearing surface of the base;
aligning the chip with the press-fit end of the display panel;
placing the buffer on the chip; and
pressing the chip by using the hot pressing head against the buffer.

11. The method of claim 10, wherein a vertical distance from a highest point to a lowest point of the convex surface is determined according to a deformation amount of a display panel caused by chip shrinkage.

12. The method of claim 10, wherein a vertical distance from a highest point to a lowest point of the convex surface is from 0.01 mm to 0.1 mm.

13. The method of claim 10, wherein the base is a quartz base.

14. The method of claim 10, wherein the base is a steel base, and a plurality of jack screws configured for adjusting a curvature of the bearing surface are disposed under the bearing surface.

15. The method of claim 10, wherein a thickness of the buffer is larger than a vertical distance from a highest point to a lowest point of the convex surface.

16. The method of claim 15, wherein the thickness of the buffer is 0.25 mm.

17. The method of claim 15, wherein the buffer comprises a silica gel buffer.

18. The method of claim 10, wherein a heating element is disposed in the base and a working temperature of the base is equal to or smaller than 120° C.
